(19) United States
(12) Patent Application Publication
(10) Pub. No.: US 2006/0262259 A1
(43) Pub. Date: Nov. 23, 2006

(54) Transflective liquid crystal display operable in optically compensated bend mode

(75) Inventors: I-An Yao, Miao-Li (TW); Chiu-Lien Yang, Miao-Li (TW); Pin-Fa Wang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/438,506

(22) Filed: May 22, 2006

(30) Foreign Application Priority Data
May 20, 2005 (TW) 94116422

(51) Int. Cl. G02F 1/1335

(52) U.S. Cl. 349/117; 349/114

(57) ABSTRACT

An exemplary transflective liquid crystal display device (100) includes a first glass substrate (110) and a second glass substrate (120); a liquid crystal layer (130) having liquid crystal molecules interposed between the first and second substrates, the liquid crystal molecules being bend-aligned whereby the liquid crystal display device to operate in an optically compensated bend (OCB) mode; a front polarizer (191) and a rear polarizer (192) disposed at two outer surfaces of the first and second substrates, respectively; a first compensation member (181) between the front polarizer and the first substrate; and a second compensation member (182) between the rear polarizer and the second substrate.

### FIELD OF THE INVENTION

The present invention relates to transflective liquid crystal displays (LCDs), and more particularly to transflective LCDs that operate in OCB (optically compensated bend) mode.

### BACKGROUND

Recently, LCDs that are light and thin and have low power consumption characteristics have been widely used in office automation equipment, video units and the like. Among LCD products, there have been the following three types of LCD devices commercially available: a reflection type LCD device utilizing ambient light, a transmission type LCD device utilizing backlight, and a transflective type LCD device equipped with a half mirror and a backlight.

With a reflection type LCD device, a display becomes less visible in a poorly lit environment. In contrast, a display of a transmission type LCD device appears hazy in strong ambient light (e.g., outdoor sunlight). Thus researchers sought to provide an LCD device capable of functioning in both modes so as to yield a satisfactory display in any environment. In due course, a transflective type LCD device was developed.

However, the transflective type LCD device typically has the following problems. The transflective type LCD device uses a half mirror instead of the reflective plate used in a reflection type LCD device, and has a minute transmission region (e.g., minute holes in a thin metal film) in a reflection region, thereby providing a display by utilizing transmitted light as well as reflected light. Since both the reflected light and the transmitted light used for the display pass through the same liquid crystal layer of the LCD device, an optical path of the reflected light is twice as long as that of the transmitted light. Thus the retardation of the liquid crystal layer with respect to the reflected light is substantially different from that with respect to the transmitted light, and a satisfactory display image cannot be obtained. Furthermore, the means for providing both a reflection mode and a transmission mode for the display are superimposed on each other, so that the respective modes cannot be separately optimized. This results in difficulty in providing a quality color display image, and tends to cause a blurred display image as well.

What is needed, therefore, is a liquid crystal display device which has equally good visual performance at various different viewing angles and a high contrast ratio.

### SUMMARY

In a preferred embodiment, a transflective LCD includes a first glass substrate and a second glass substrate; a liquid crystal layer having liquid crystal molecules interposed between the first and second substrates, the liquid crystal molecules being bend-aligned whereby the liquid crystal display device to operate in an optically compensated bend (OCB) mode; a front polarizer and a rear polarizer disposed at two outer surfaces of the first and second substrates, respectively; a first compensation member between the front polarizer and the first substrate; and a second compensation member between the rear polarizer and the second substrate.

Further, the transflective LCD device preferably includes a first front compensation plate, a second front compensation plate, and a front retardation film. Preferably, the first front compensation plate is a C-compensation plate, the second front compensation plate is an A-compensation plate, and the front retardation film is a quarter-wave plate.

According to other embodiments, the transflective LCD device preferably includes a first rear compensation plate, a second rear compensation plate, and a rear retardation film; and the first rear compensation plate is a C-compensation plate, the second rear compensation plate is an A-compensation plate, and the rear retardation film is a quarter-wave plate.

Other advantages and novel features will become more apparent from the following detailed description when taken in conjunction with the accompanying drawings, in which:

### BRIEF DESCRIPTION OF THE DRAWINGS

FIG. 1 is a schematic, exploded, side cross-sectional view of three pixel regions of a transflective LCD according to a first preferred embodiment of the present invention;

FIG. 2 is a schematic, exploded, side cross-sectional view of a pixel region of a transflective LCD according to a second preferred embodiment of the present invention, the transflective LCD defining a transmission region and a reflection region;

FIG. 3 is a graph illustrating contrast ratio characteristics of the transmission region of the transflective LCD of FIG. 2, when light is incident and received at a wavelength of 560 nm;

FIG. 4 is a graph illustrating contrast ratio characteristics of the reflection region of the transflective LCD of FIG. 2, when light is incident and received at a wavelength of 560 nm;

FIG. 5 is a graph illustrating gray scale performance along a horizontal direction of the transmission region of the transflective LCD of FIG. 2, when different voltages are applied;

FIG. 6 is a graph illustrating gray scale performance along a horizontal direction of the reflection region of the transflective LCD of FIG. 2, when different voltages are applied;

FIG. 7 is a graph illustrating gray scale performance along a vertical direction of the transmission region of the transflective LCD of FIG. 2, when different voltages are applied;

FIG. 8 is a graph illustrating gray scale performance along a vertical direction of the reflection region of the transflective LCD of FIG. 2, when different voltages are applied;

FIG. 9 is a schematic, exploded, side cross-sectional view of a pixel region of a transflective LCD according to a third preferred embodiment of the present invention, the transflective LCD defining a transmission region and a reflection region;

FIG. 10 is a graph illustrating contrast ratio characteristics of the transmission region of the transflective LCD of FIG. 9, when light is incident and received at a wavelength of 560 nm;

FIG. 11 is a graph illustrating contrast ratio characteristics of the reflection region of the transflective LCD of FIG. 9, when light is incident and received at a wavelength of 560 nm;

FIG. 12 is a graph illustrating gray scale performance along a horizontal direction of the transmission region of the transflective LCD of FIG. 9, when different voltages are applied;

FIG. 13 is a graph illustrating gray scale performance along a horizontal direction of the reflection region of the transflective LCD of FIG. 9, when different voltages are applied;

FIG. 14 is a graph illustrating gray scale performance along a vertical direction of the transmission region of the transflective LCD of FIG. 9, when different voltages are applied;

FIG. 15 is a graph illustrating gray scale performance along a vertical direction of the reflection region of the transflective LCD of FIG. 9, when different voltages are applied;

FIG. 16 is a schematic, exploded, side cross-sectional view of a pixel region of a transflective LCD according to a fourth preferred embodiment of the present invention, the transflective LCD defining a transmission region and a reflection region;

FIG. 17 is a graph illustrating contrast ratio characteristics of the transmission region of the transflective LCD of FIG. 16, when light is incident and received at a wavelength of 560 nm;

FIG. 18 is a graph illustrating contrast ratio characteristics of the reflection region of the transflective LCD of FIG. 16, when light is incident and received at a wavelength of 560 nm;

FIG. 19 is a graph illustrating gray scale performance along a horizontal direction of the transmission region of the transflective LCD of FIG. 16, when different voltages are applied;

FIG. 20 is a graph illustrating gray scale performance along a horizontal direction of the reflection region of the transflective LCD of FIG. 16, when different voltages are applied;

FIG. 21 is a graph illustrating gray scale performance along a vertical direction of the transmission region of the transflective LCD of FIG. 16, when different voltages are applied;

FIG. 22 is a graph illustrating gray scale performance along a vertical direction of the reflection region of the transflective LCD of FIG. 16, when different voltages are applied;

FIG. 23 is a schematic, exploded, side cross-sectional view of a transflective LCD according to a fifth preferred embodiment of the present invention, the transflective LCD defining a transmission region and a reflection region;

FIG. 24 is a graph illustrating contrast ratio characteristics of the transmission region of the transflective LCD of FIG. 23, when light is incident and received at a wavelength of 560 nm;

FIG. 25 is a graph illustrating contrast ratio characteristics of the reflection region of the transflective LCD of FIG. 23, when light is incident and received at a wavelength of 560 nm;

FIG. 26 is a graph illustrating gray scale performance along a horizontal direction of the transmission region of the transflective LCD of FIG. 23, when different voltages are applied;

FIG. 27 is a graph illustrating gray scale performance along a horizontal direction of the reflection region of the transflective LCD of FIG. 23, when different voltages are applied;

FIG. 28 is a graph illustrating gray scale performance along a vertical direction of the transmission region of the transflective LCD of FIG. 23, when different voltages are applied;

FIG. 29 is a graph illustrating gray scale performance along a vertical direction of the reflection region of the transflective LCD of FIG. 23, when different voltages are applied;

FIG. 30 is a schematic, exploded, side cross-sectional view of a transflective LCD according to a sixth preferred embodiment of the present invention, the transflective LCD defining a transmission region and a reflection region;

FIG. 31 is a graph illustrating contrast ratio characteristics of the transmission region of the transflective LCD of FIG. 30, when light is incident and received at a wavelength of 560 nm;

FIG. 32 is a graph illustrating contrast ratio characteristics of the reflection region of the transflective LCD of FIG. 30, when light is incident and received at a wavelength of 560 nm;

FIG. 33 is a graph illustrating gray scale performance along a horizontal direction of the transmission region of the transflective LCD of FIG. 30, when different voltages are applied;

FIG. 34 is a graph illustrating gray scale performance along a horizontal direction of the reflection region of the transflective LCD of FIG. 30, when different voltages are applied;

FIG. 35 is a graph illustrating gray scale performance along a vertical direction of the transmission region of the transflective LCD of FIG. 30, when different voltages are applied;

FIG. 36 is a graph illustrating gray scale performance along a vertical direction of the reflection region of the transflective LCD of FIG. 30, when different voltages are applied;

FIG. 37 is a schematic, exploded, side cross-sectional view of a transflective LCD according to a seventh preferred embodiment of the present invention, the transflective LCD defining a transmission region and a reflection region;

FIG. 38 is a graph illustrating contrast ratio characteristics of the transmission region of the transflective LCD of FIG. 37, when light is incident and received at a wavelength of 560 nm;

FIG. 39 is a graph illustrating contrast ratio characteristics of the reflection region of the transflective LCD of FIG. 37, when light is incident and received at a wavelength of 560 nm;

FIG. 40 is a graph illustrating gray scale performance along a horizontal direction of the transmission region of the transflective LCD of FIG. 37, when different voltages are applied;

FIG. 41 is a graph illustrating gray scale performance along a horizontal direction of the reflection region of the transflective LCD of FIG. 37, when different voltages are applied;

FIG. 42 is a graph illustrating gray scale performance along a vertical direction of the transmission region of the transflective LCD of FIG. 37, when different voltages are applied; and

FIG. 43 is a graph illustrating gray scale performance along a vertical direction of the reflection region of the transflective LCD of FIG. 37, when different voltages are applied.

### DETAILED DESCRIPTION OF PREFERRED EMBODIMENTS

FIG. 1 is a schematic, exploded, side cross-sectional view of three pixel regions of a transflective LCD 100 according to a first preferred embodiment of the present invention. The transflective LCD 100 includes a first substrate assembly 101, a second substrate assembly 102 opposite to the first substrate assembly 101, and a liquid crystal layer 130 interposed between the first and second substrate assemblies 101, 102.

As shown in FIG. 1, the first substrate assembly 101 includes a front polarizer 191, a front compensate member 181, a first glass substrate 110, a common electrode 141 and a front alignment film 151, which are laminated one on the other in that order from top to bottom. The front polarizer 191 and the front compensation member 181 are disposed on an outer surface of the first glass substrate 110, in that order from top to bottom. The front alignment film 151 and the common electrode 141 are are disposed at an inner surface of the first glass substrate 110, in that order from bottom to top.

The second substrate assembly 102 includes a rear alignment film 152, a plurality of pixel electrodes 142, a second glass substrate 120, a rear compensation member 182 and a rear polarizer 192, which are laminated one on the other in that order from top to bottom. Each pixel electrode 142 has a transmission electrode 143 and a reflective electrode 144. A passivation layer 160 is disposed between the reflection electrodes 144 and the second glass substrate 120. In accordance with an exemplary embodiment of the present invention, the transmission electrodes 143 are made of a transparent conductive material such as indium-tin-oxide (ITO) or indium-zinc-oxide (IZO), and the reflection electrodes 144 are made of metal with a high reflective ratio such as aluminum (Al).

The liquid crystal layer 130, the common electrode 141, the transmission electrodes 143, and the reflection electrodes 144 cooperatively define a plurality of pixel regions. Each pixel region includes a reflection region corresponding to a respective reflection electrode 144, and a transmission region corresponding to a respective transmission electrode 143. When a voltage is applied to the transflective LCD 100, an electric field is generated between the common electrode 141, the transmission electrodes 143, and the reflection electrodes 144. The electric field can control the orientation of liquid crystal molecules (not labeled) in the liquid crystal layer 130 in order to display images.

In assembly, the liquid crystal molecules are bend-aligned to enable the transflective LCD 100 to operate in an optically compensated bend (OCB) mode. A pretilt angle of the liquid crystal molecules adjacent to the substrate assemblies 101 and 102 is in a range of 0° to 15°. An absorption axis of the front polarizer 191 is parallel to the orientation direction of the liquid crystal molecules in the liquid crystal layer 130, and the absorption axis of the front polarizer 191 is orthogonal to an absorption axis of the rear polarizer 192. A thickness of the liquid crystal layer 130 in the reflection regions is less than a thickness of the liquid crystal layer 130 in the transmission regions.

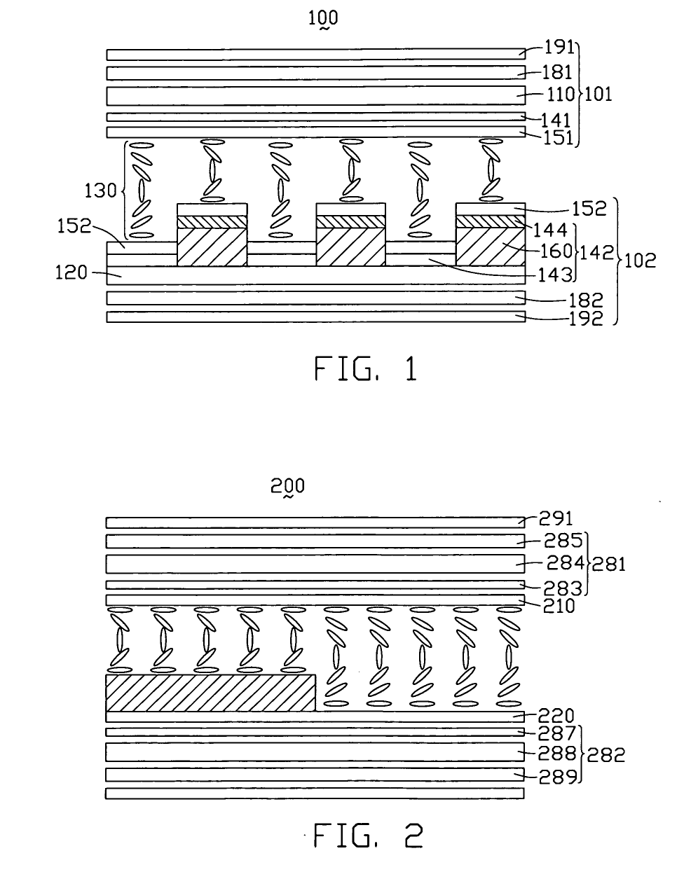

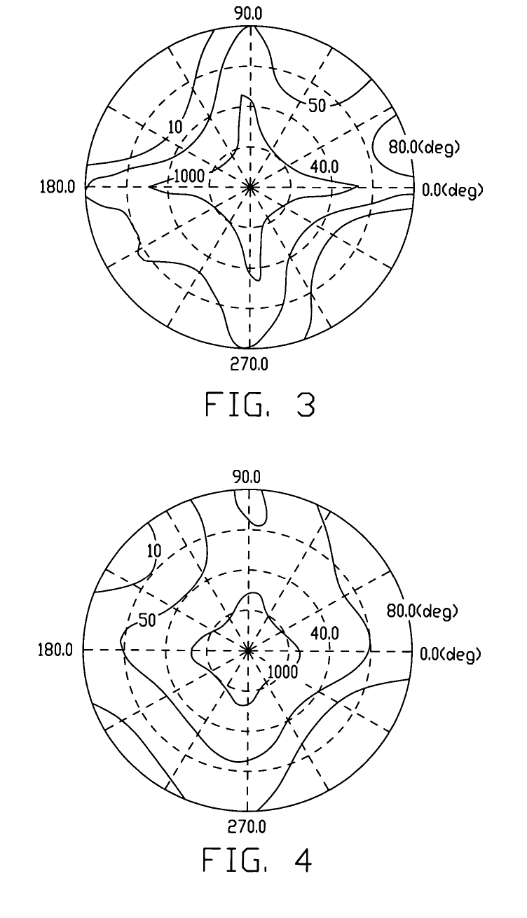

FIG. 2 is a schematic, exploded, side cross-sectional view of a pixel region of a transflective LCD 200 according to a second embodiment of the present invention. The transflective LCD 200 is similar to the transflective LCD 100 of FIG. 1. However, a front compensation member 281 of the transflective LCD 200 includes a first front compensation plate 283, a second front compensation plate 284, and a front retardation film 285. The first front compensation plate 283, the second front compensation plate 284 and the front retardation film 285 are disposed in that order on an outer surface of a first glass substrate 210. A rear compensation member 282 of the transflective LCD 200 includes a first rear compensation plate 287, a second rear compensation plate 288, and a rear retardation film 289. The first rear compensation plate 287, the second rear compensation plate 288 and the rear retardation film 289 are disposed in that order on an outer surface of a second glass substrate 220.

The first front and rear compensation plates 283, 287 are C-plate compensation plates, each of which is made from a uniaxial crystal for positively compensating contrast ratio. The second front and rear compensation plates 284, 288 are A-plate compensation plates, each of which is made from a uniaxial crystal for negatively compensating the contrast ratio. The first front and rear retardation films 285, 289 are each a quarter-wave plate. A slow axis of the second front compensation plate 284 maintains an angle of 90 degrees relative to an absorption axis of a front polarizer 291, and a slow axis of the first front compensation plate 283 maintains an angle of 45 degrees relative to the absorption axis of the front polarizer 291. A slow axis of the second rear compensation plate 288 is parallel to the slow axis of the second front compensation plate 284, and a slow axis of the rear retardation film 289 is orthogonal to the slow axis of the front retardation film 285.

In each pixel region of the transflective LCD 200, the liquid crystal molecules (not labeled) have a pre-tilt angle, which ensures that the liquid crystal molecules can more easily adjust their orientation when a voltage is applied to the transflective LCD 200 and a change in a driving electric field is effected. Thereby, the transflective LCD 200 has a fast response time. Moreover, the retardation films and the compensation plates are used for compensating for color, so as to ensure that the transflective LCD 200 has improved contrast and viewing angle characteristics and displays good quality images.

FIG. 3 and FIG. 4 are computer simulation contrast ratio graphs for the transmission region and the reflection region of the transflective LCD 200 when light having a wavelength of 560 nm is utilized. As shown in FIG. 3 and FIG. 4, the 10:1 contrast ratio curve extends horizontally along the 0° vertical viewing axis a total of more than 160°, and extends vertically along the 0° horizontal viewing axis a total of more than 160°, which shows that a large viewing angle is obtained.

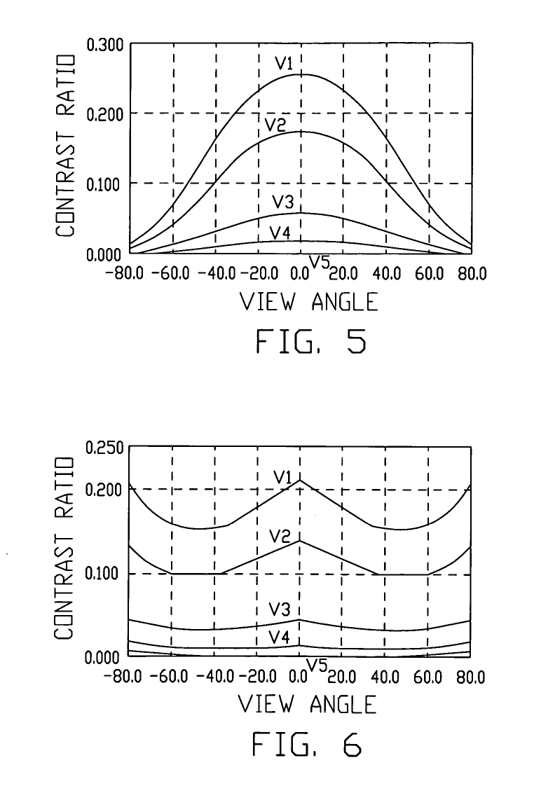

FIG. 5 and FIG. 6 illustrate gray scale performance along a horizontal direction of the transmission region and the reflection region of the transflective LCD 200, respectively, when different voltages are applied. In FIG. 5 and FIG. 6, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 5 and FIG. 6, no gray scale inversion is produced along a horizontal direction along the 0° vertical viewing axis from −80° to 80°.

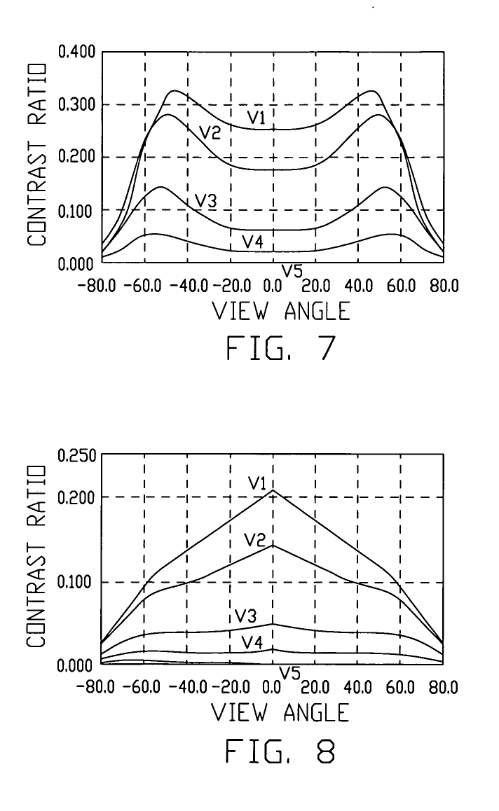

FIG. 7 and FIG. 8 illustrate gray scale performance along a vertical direction of the transmission region and the reflection region of the transflective LCD 200, respectively, when different voltages are applied. As shown in FIG. 7 and FIG. 8, no gray level inversion is produced along a vertical direction along the 0° horizontal viewing axis from −80° to 80°.

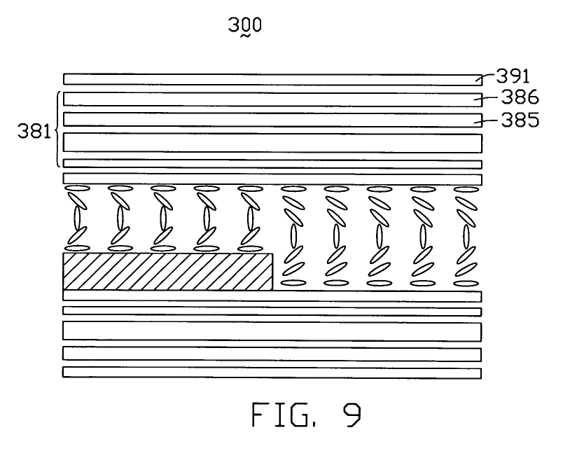

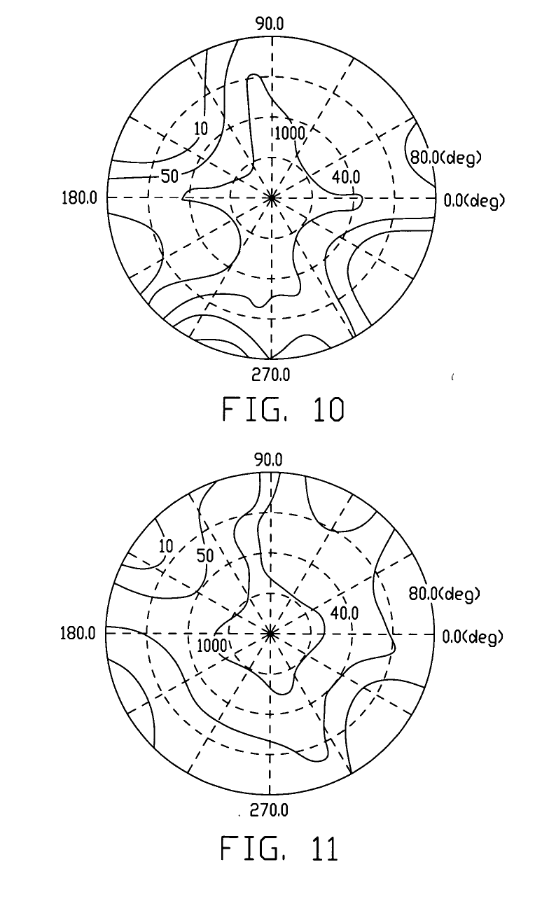

FIG. 9 is a schematic, exploded, side cross-sectional view of a pixel region of a transflective LCD 300 according to a third embodiment of the present invention. The transflective LCD 300 is similar to the transflective LCD 200 of FIG. 2. However, a front compensation member 381 of the transflective LCD 300 further includes a third front compensation plate 386 disposed between a front retardation film 385 and a front polarizer 391. The third front compensation plate 386 is an A-plate compensation plate, a slow axis of the third front compensation plate 386 being orthogonal to an absorption axis of the front polarizer 391.

FIG. 10 and FIG. 11 are computer simulation contrast ratio graphs for the transmission region and the reflection region of the transflective LCD 300 when light having a wavelength of 560 nm is utilized. As shown in FIG. 10 and FIG. 11, the 10:1 contrast ratio curve extends horizontally along the 0° vertical viewing axis a total of more than 160°, and extends vertically along the 0° horizontal viewing axis a total of more than 160°, which shows that a large viewing angle is obtained.

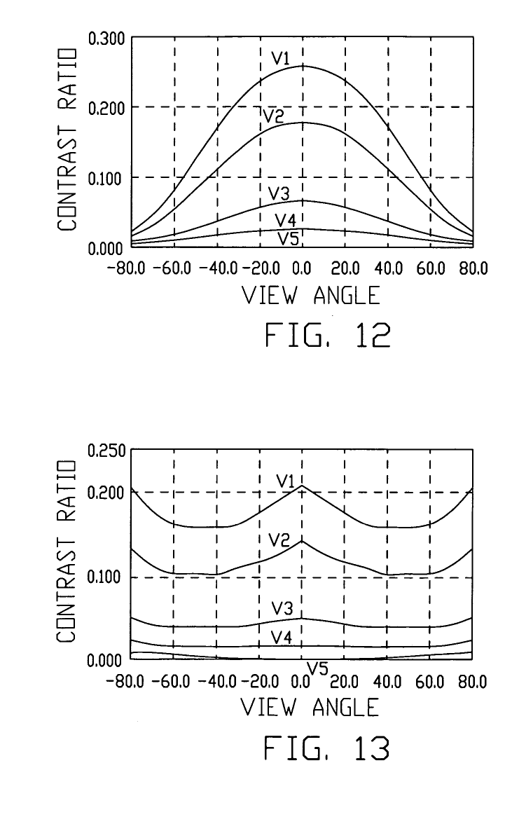

FIG. 12 and FIG. 13 illustrate gray scale performance along a horizontal direction of the transmission region and the reflection region of the transflective LCD 300, respectively, when different voltages are applied. In FIG. 12 and FIG. 13, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 12 and FIG. 13, no gray scale inversion is produced along a horizontal direction along the 0° vertical viewing axis from −80° to 80°, when different voltages are provided.

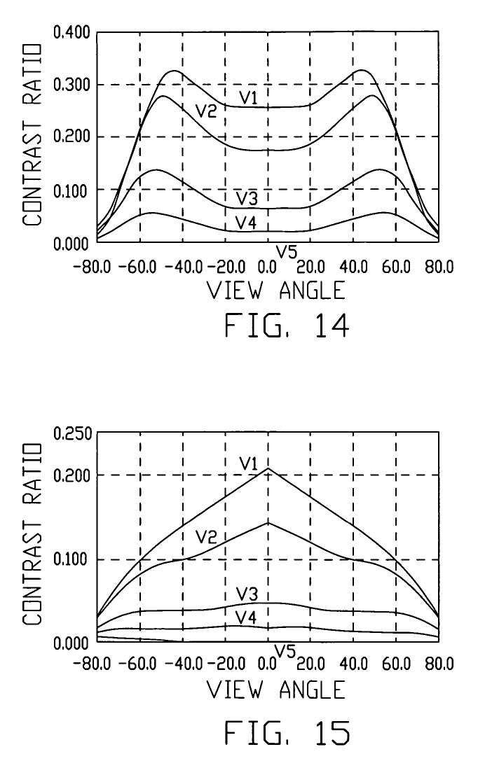

FIG. 14 and FIG. 15 illustrate gray scale performance performance along a vertical direction of the transmission region and the reflection region of the transflective LCD 300, respectively, when different voltages are applied. As shown in FIG. 14 and FIG. 15, no gray level inversion is produced along a vertical direction along the 0° horizontal viewing axis from −80° to 80°.

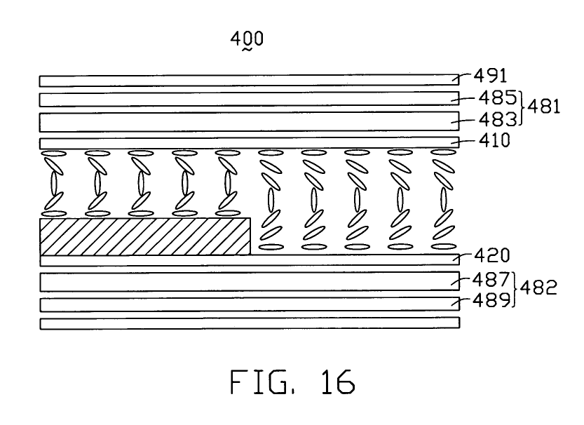

FIG. 16 is a schematic, exploded, side cross-sectional view of a pixel region of a transflective LCD 400 according to a fourth embodiment of the present invention. The transflective LCD 400 is similar to the transflective LCD 100 of FIG. 1. However, a front compensation member 481 of the transflective LCD 400 includes a first front compensation plate 483 and a front retardation film 485. The first front compensation plate 483 and the front retardation film 485 are disposed in that order on an outer surface of a first glass substrate 410. A rear compensation member 482 of the transflective LCD 400 includes a first rear compensation plate 487 and a rear retardation film 489. The first rear compensation plate 487 and the rear retardation film 489 are disposed in that order on an outer surface of a second glass substrate 420.

The first front and rear compensation plates 483, 487 are biaxial compensation plates, which are made from biaxial crystal. The first front and rear retardation film 485, 489 are quarter-wave plates. A slow axis of the first front compensation plate 483 is orthogonal to an absorption axis of a front polarizer 491, and a slow axis of the front retardation film 485 maintains an angle of 45 degrees relative to the absorption axis of the front polarizer 491. A slow axis of the first rear compensation plate 487 is parallel to the slow axis of the first front compensation plate 483, and a slow axis of the rear retardation film 489 is orthogonal to the slow axis of the front retardation film 485.

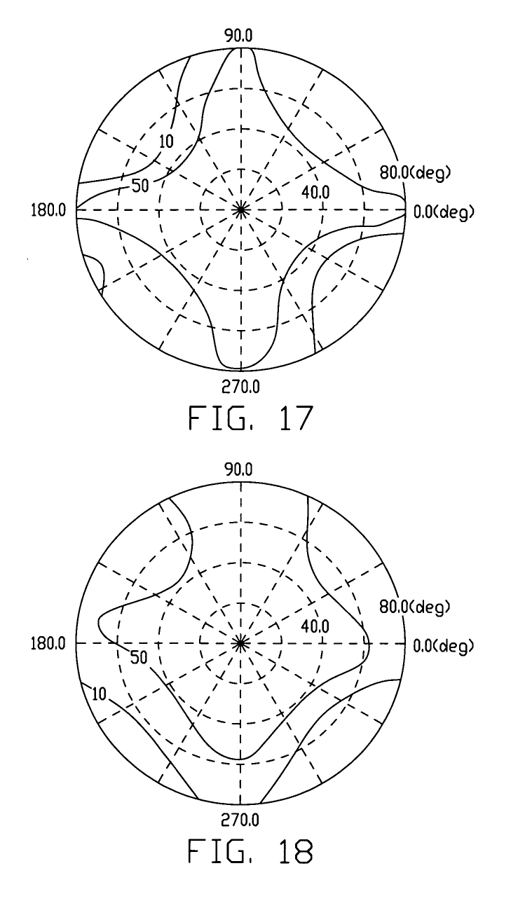

FIG. 17 and FIG. 18 are computer simulation contrast ratio graphs for the transmission region and the reflection region of the transflective LCD 400 when light having a wavelength of 560 nm is utilized. As shown in FIG. 17 and FIG. 18, the 10:1 contrast ratio curve extends horizontally along the 0° vertical viewing axis a total of more than 160°, and extends vertically along the 0° horizontal viewing axis a total of more than 160°, which shows that a large viewing angle is obtained.

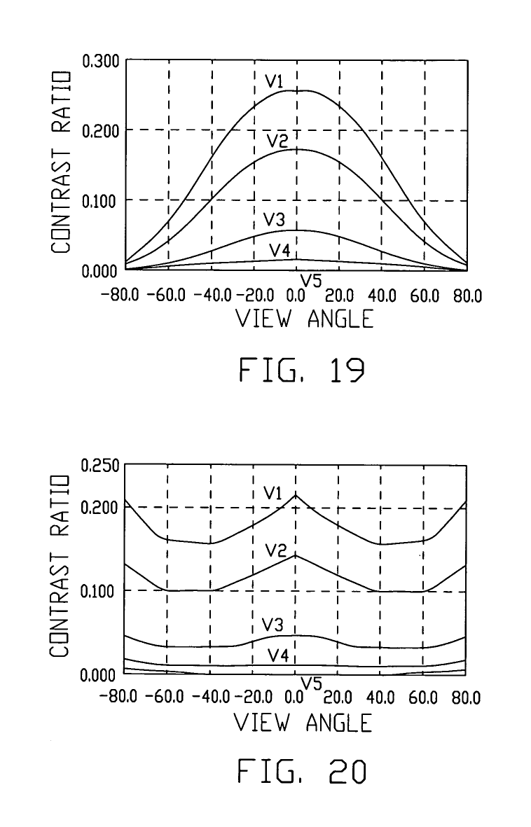

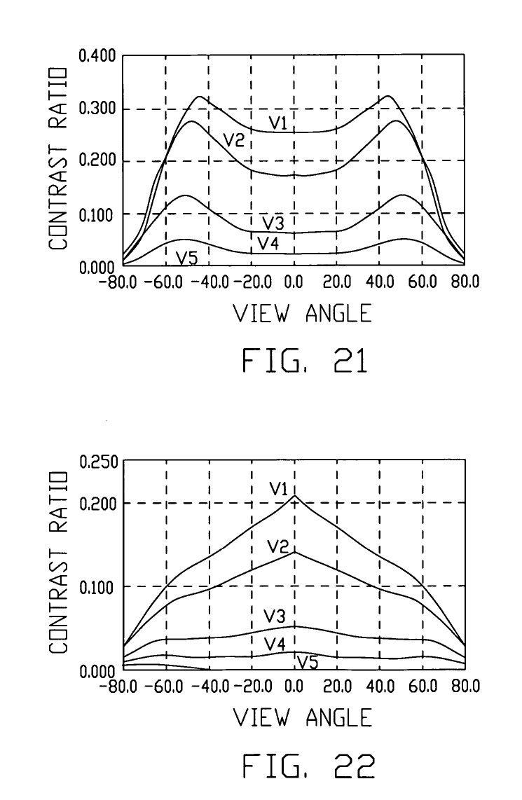

FIG. 19 and FIG. 20 illustrate gray scale performance along a horizontal direction of the transmission region and the reflection region of the transflective LCD 400, respectively, when different voltages are applied. In FIG. 19 and FIG. 20, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 19 and FIG. 20, no gray scale inversion is produced along a horizontal direction along the 0° vertical viewing axis from −80° to 80°.

FIG. 21 and FIG. 22 illustrate gray scale performance along a vertical direction of the transmission region and the reflection region of the transflective LCD 400, respectively, when different voltages are applied. As shown in FIG. 21 and FIG. 22, no gray level inversion is produced along a vertical direction along the 0° horizontal viewing axis from −80°0 to 80°.

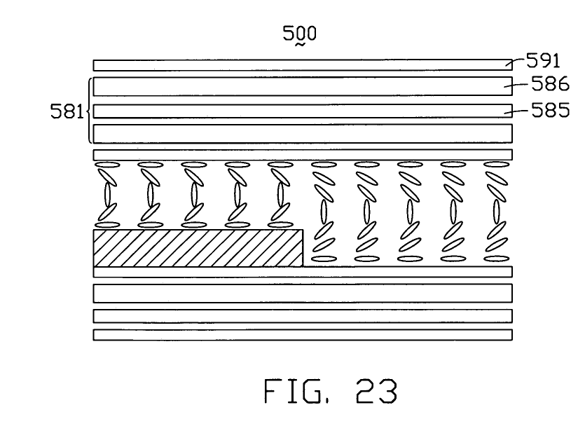

FIG. 23 is a schematic, exploded, side cross-sectional view of a pixel region of a transflective LCD 500 according to a fifth embodiment of the present invention. The transflective LCD 500 is similar to the transflective LCD 400 of FIG. 16. However, a front compensation member 581 of the transflective LCD 500 further includes a second front compensation plate 586 disposed between a front retardation film 585 and a front polarizer 591. The second front compensation plate 586 is an A-plate compensation plate, a slow axis of the second front compensation plate 586 being orthogonal to an absorption axis of the front polarizer 591.

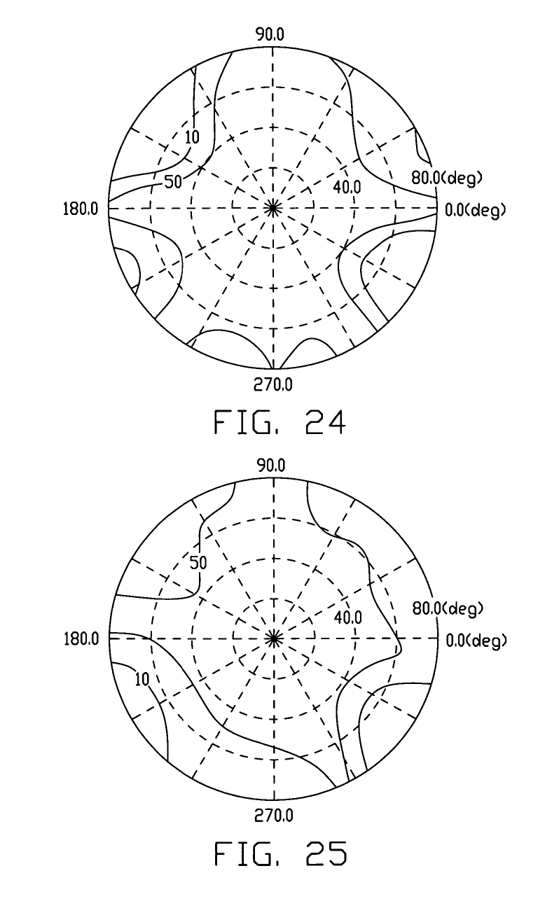

FIG. 24 and FIG. 25 are computer simulation contrast ratio graphs for the transmission region and the reflection region of the transflective LCD 500 when light having a wavelength of 560 nm is utilized. As shown in FIG. 24 and FIG. 25, the 10:1 contrast ratio curve extends horizontally along the 0° vertical viewing axis a total of more than 160°, and extends vertically along the 0° horizontal viewing axis a total of more than 160°, which shows that a large viewing angle is obtained.

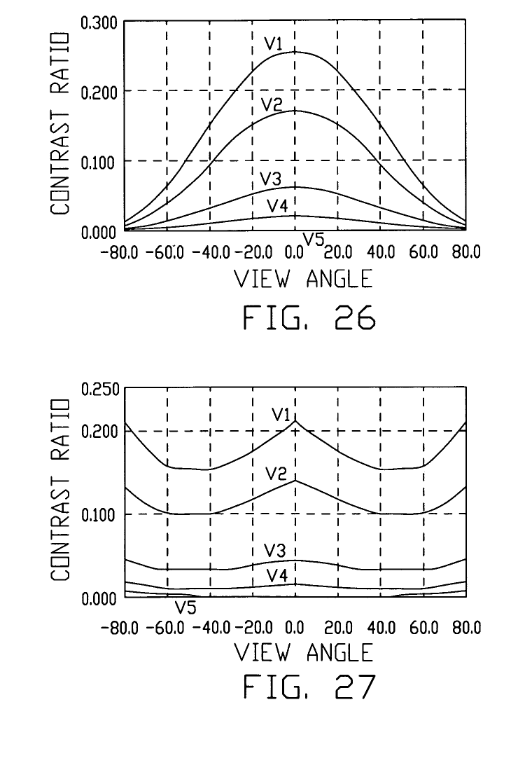

FIG. 26 and FIG. 27 illustrate gray scale performance along a horizontal direction of the transmission region and the reflection region of the transflective LCD 500, respectively, when different voltages are provided. In FIG. 26 and FIG. 27, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 26 and FIG. 27, no gray scale inversion is produced at a horizontal direction along the 0° vertical viewing axis from −80° to 80°.

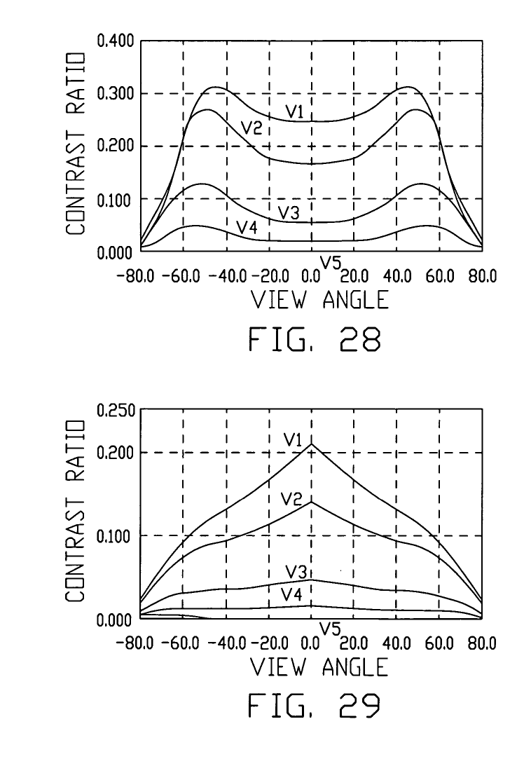

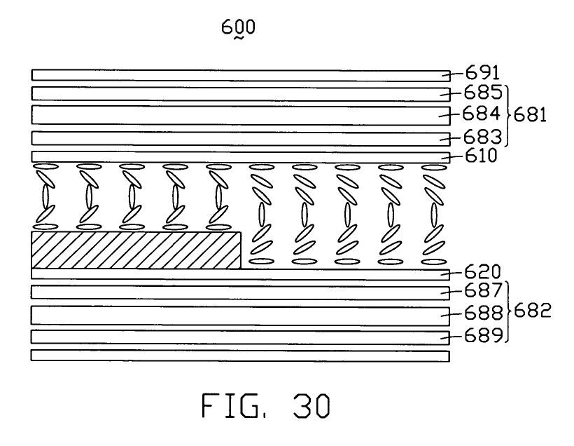

FIG. 28 and FIG. 29 illustrate gray scale performance along a vertical direction of the transmission region and the reflection region of the transflective LCD 500, respectively, when different voltages are applied. As shown in FIG. 28 and FIG. 29, no gray level inversion is produced along a vertical direction along the 0° horizontal viewing axis from −80° to 80°.

FIG. 30 is a schematic, exploded, side cross-sectional view of a pixel region of a transflective LCD 600 according to a sixth embodiment of the present invention. The transflective LCD 600 is similar to the transflective LCD 200 of FIG. 2. However, a front compensation member 681 of the transflective LCD 600 includes a first front compensation plate 683, a second front compensation plate 684, and a front retardation film 685. The first front compensation plate 683, the second front compensation plate 684 and the front retardation film 685 are disposed in that order on an outer surface of a first glass substrate 610. A rear compensation member 682 of the transflective LCD 600 includes a first rear compensation plate 687, a second rear compensation plate 688, and a rear retardation film 689. The first rear compensation plate 687, the second rear compensation plate 688 and the rear retardation film 689 are disposed in that order on an outer surface of a second glass substrate 620.

The first front and rear compensation plates 683, 687 are hybrid C-plate compensation plates, which are made from a uniaxial crystal. The second front and rear compensation plates 684, 688 are C-plate compensation plates. The front and rear retardation films 685, 689 are quarter-wave plates. A slow axis of the first front compensation plate 683 maintains an angle of 45 degrees relative to an absorption axis of a front polarizer 691, and a slow axis of the rear retardation film 689 is orthogonal to a slow axis of the front retardation film 685.

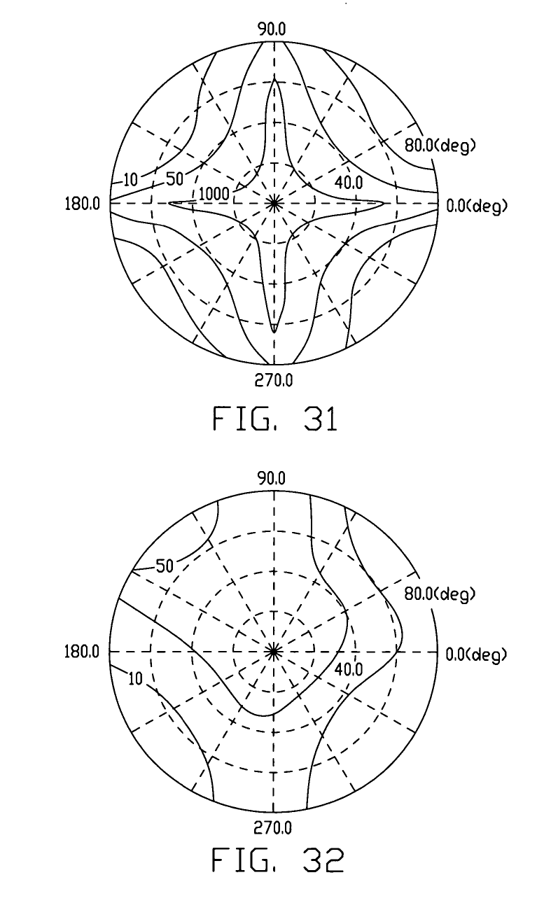

FIG. 31 and FIG. 32 are computer simulation contrast ratio graphs for the transmission region and the reflection region of the transflective LCD 600 when light having a wavelength of 560 nm is utilized. As shown in FIG. 31 and FIG. 32, the 10:1 contrast ratio curve extends horizontally along the 0° vertical viewing axis a total of more than 160°, and extends vertically along the 0° horizontal viewing axis a total of more than 160°, which shows that a large viewing angle is obtained.

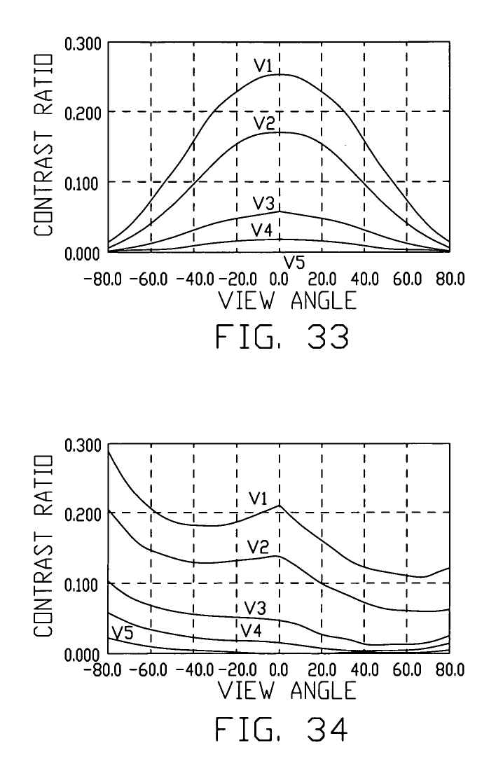

FIG. 33 and FIG. 34 illustrate gray scale performance along a horizontal direction of the transmission region and the reflection region of the transflective LCD 600, respectively, when different voltages are applied. In FIG. 33 and FIG. 34, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 33 and FIG. 34, no gray scale inversion is produced along a horizontal direction along the 0° vertical viewing axis from −80° to 80°.

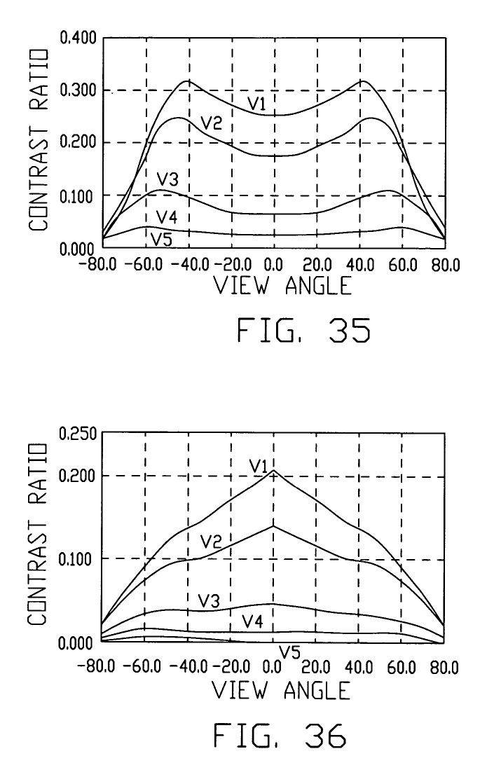

FIG. 35 and FIG. 36 illustrate gray scale performance along a vertical direction of the transmission region and the reflection region of the transflective LCD 400, respectively, when different voltages are applied. As shown in FIG. 35 and FIG. 36, no gray level inversion is produced along a vertical direction along the 0° horizontal viewing axis from −80° to 80°.

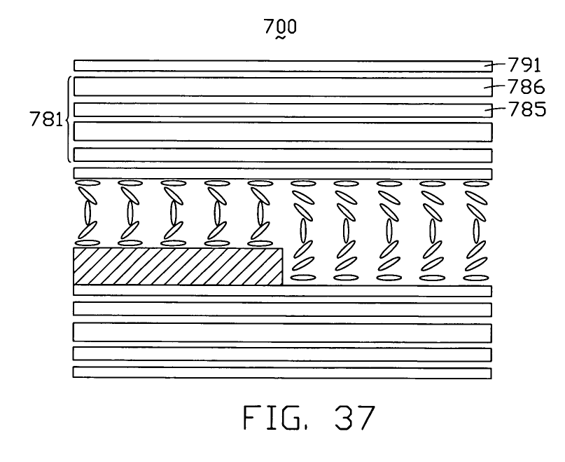

FIG. 37 is a schematic, exploded, side cross-sectional view of a pixel region of a transflective LCD 700 according to a seventh embodiment of the present invention. The transflective LCD 700 is similar to the transflective LCD 600 of FIG. 30. However, a front compensation member 781 of the transflective LCD 700 further includes a third front compensation plate 786 disposed between a front retardation film 785 and a front polarizer 791. The third front compensation plate 786 is an A-plate compensation plate, a slow axis of the third front compensation plate 786 being orthogonal to an absorption axis of the front polarizer 791.

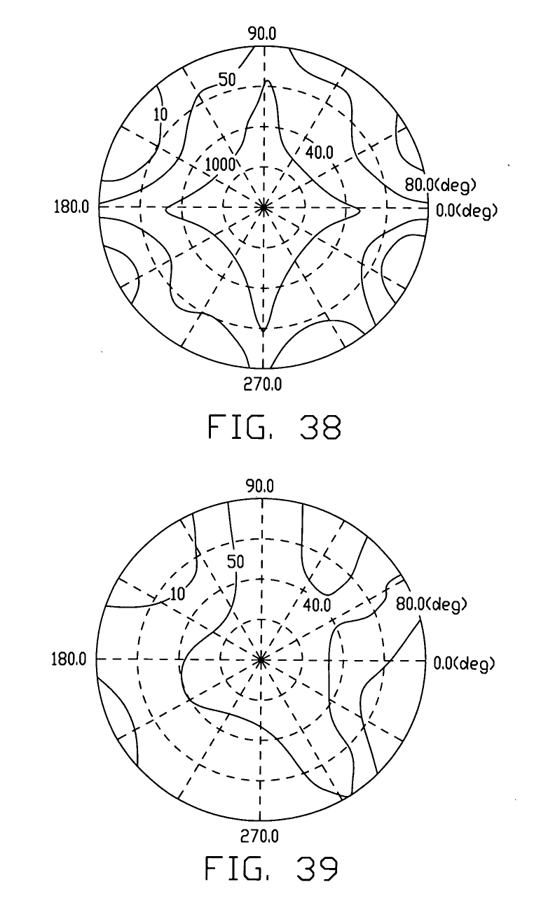

FIG. 38 and FIG. 39 are computer simulation contrast ratio graphs for the transmission region and the reflection region of the transflective LCD 600 when light having a wavelength of 560 nm is utilized. As shown in FIG. 38 and FIG. 39, the 10:1 contrast ratio curve extends horizontally along the 0° vertical viewing axis a total of more than 160°, and extends vertically along the 0° horizontal viewing axis a total of more than 160°, which shows that a large viewing angle is obtained.

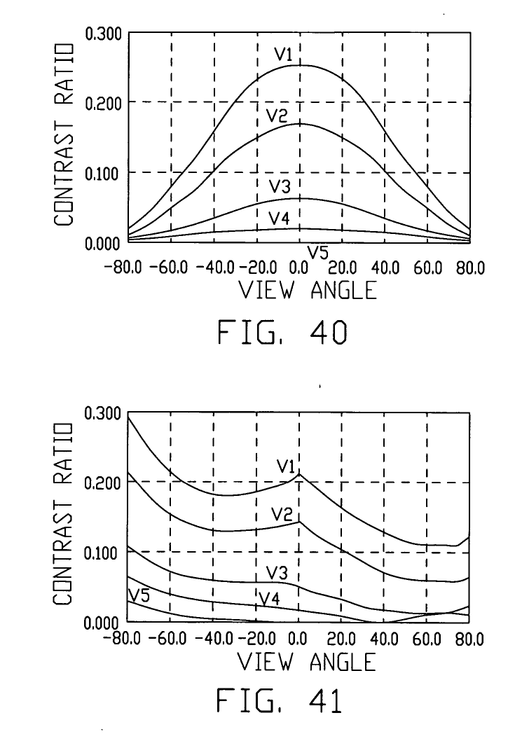

FIG. 40 and FIG. 41 illustrate gray scale performance along a horizontal direction of the transmission region and the reflection region of the transflective LCD 600, respectively, when different voltages are applied. In FIG. 40 and FIG. 41, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 40 and FIG. 41, no gray scale inversion is produced along a horizontal direction along the 0° vertical viewing axis from −80° to 80°.

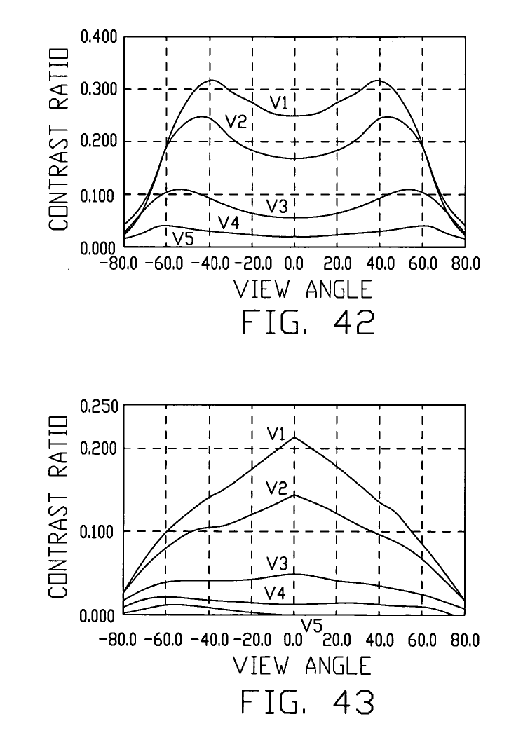

FIG. 42 and FIG. 43 illustrate gray scale performance along a vertical direction of the transmission region and the reflection region of the transflective LCD 400, respectively, when different voltages are applied. As shown in FIG. 42 and FIG. 43, no gray level inversion is produced along a vertical direction along the 0° horizontal viewing axis from −80° to 80°.

In each pixel region of each of the above-described transflective LCDs, the liquid crystal molecules have a pre-tilt angle, which ensures that the liquid crystal molecules can more easily adjust their orientation when a voltage is applied to the transflective LCD and a change in a driving electric field is effected. Thereby, the transflective LCDs have a fast response time. Moreover, the retardation films and the compensation plates are used for compensating for color, so as to ensure that the transflective LCDs have improved contrast and viewing angle characteristics and display good quality images.

It is to be understood, however, that even though numerous characteristics and advantages of various embodiments of the present invention have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A transflective liquid crystal display device, comprising:
a first substrate and a second substrate;
a liquid crystal layer having liquid crystal molecules interposed between the first and second substrates, the liquid crystal molecules being bend-aligned whereby the liquid crystal display device operates in an optically compensated bend (OCB) mode;
a front polarizer and a rear polarizer disposed at two outer surfaces of the first and second substrates, respectively;
a first compensation member between the front polarizer and the first substrate; and
a second compensation member between the rear polarizer and the second substrate.

2. The transflective liquid crystal display device as claimed in claim 1, wherein a pretilt angle of liquid crystal molecules adjacent to the first and second substrates is in a range of 0° to 15°.

3. The transflective liquid crystal display device as claimed in claim 2, further comprising a plurality of transmission electrodes at an inner surface of the second substrate corresponding to transmission regions of the liquid crystal display device, and a plurality of reflection electrodes disposed at the inner surface of the second substrate corresponding to reflection regions of the liquid crystal display device.

4. The transflective liquid crystal display device as claimed in claim 3, further comprising a passivation layer disposed between the reflection electrodes and the second substrate.

5. The transflective liquid crystal display device as claimed in claim 1, wherein the first compensation member comprises a first front compensation plate, a second front compensation plate, and a front retardation film, disposed in that order at an outer surface of the first substrate.

6. The transflective liquid crystal display device as claimed in claim 5, wherein the first front compensation plate is a C-compensation plate, the second front compensation plate is an A-compensation plate, and the front retardation film is a quarter-wave plate.

7. The transflective liquid crystal display device as claimed in claim 5, wherein the second compensation member comprises a first rear compensation plate, a second rear compensation plate, and a rear retardation film, disposed in that order at an outer surface of the second substrate.

8. The transflective liquid crystal display device as claimed in claim 7, wherein the first rear compensation plate is a C-compensation plate, the second rear compensation plate is an A-compensation plate, and the rear retardation film is a quarter-wave plate.

9. The transflective liquid crystal display device as claimed in claim 7, wherein a slow axis of the second front compensation plate maintains an angle of 90 degrees relative to an absorption axis of the front polarizer, a slow axis of the first front compensation plate maintains an angle of 45 degrees relative to the absorption axis of the front polarizer, a slow axis of the second rear compensation plate is parallel to the slow axis of the second front compensation plate, and a slow axis of the rear retardation film is orthogonal to a slow axis of the front retardation film.

10. The transflective liquid crystal display device as claimed in claim 7, wherein the first compensation member further comprises a third front compensation plate disposed between the front retardation film and the front polarizer.

11. The transflective liquid crystal display device as claimed in claim 10, wherein the third front compensation plate is an A-compensation plate, and a slow axis of the third front compensation plate is orthogonal to the absorption axis of the front polarizer.

12. The transflective liquid crystal display device as claimed in claim 1, wherein the front compensation member includes a first front compensation plate and a front retardation film, disposed in that order at an outer surface of the first substrate.

13. The transflective liquid crystal display device as claimed in claim 12, wherein the rear compensation member includes a first rear compensation plate and a rear retardation film, disposed in that order at an outer surface of the second substrate.

14. The transflective liquid crystal display device as claimed in claim 13, wherein the first front and rear compensation plates are biaxial compensation plates, and the front and rear retardation films are quarter-wave plates.

15. The transflective liquid crystal display device as claimed in claim 14, wherein a slow axis of the first front compensation plate is orthogonal to an absorption axis of the front polarizer, a slow axis of the front retardation film maintains an angle of 45 degrees relative to the absorption axis of the front polarizer, a slow axis of the first rear compensation plate is parallel to the slow axis of the first front compensation plate, and a slow axis of the rear retardation film is orthogonal to the slow axis of the front retardation film.

16. The transflective liquid crystal display device as claimed in claim 13, wherein the front compensation member further includes a third front compensation plate disposed between the front retardation film and the front polarizer.

17. The transflective liquid crystal display device as claimed in claim 16, wherein the third front compensation plate is an A-plate compensation plate, and a slow axis of the third front compensation plate is orthogonal to an absorption axis of the front polarizer.

18. The transflective liquid crystal display device as claimed in claim 7, wherein the first front and rear compensation plates are hybrid C-plate compensation plates, the second front and rear compensation plates are C-plate compensation plates, and the front and rear retardation films are quarter-wave plates.

19. The transflective liquid crystal display device as claimed in claim 18, wherein a slow axis of the first front compensation plate maintains an angle of 45 degrees relative to an absorption axis of the front polarizer, and a slow axis of the rear retardation film is orthogonal to a slow axis of the front retardation film.

20. The transflective liquid crystal display device as claimed in claim 18, wherein the front compensation member further includes a third front compensation plate disposed between the front retardation film and the front polarizer, the third front compensation plate is an A-plate compensation plate, and a slow axis of the third front compensation plate is orthogonal to an absorption axis of the front polarizer.
